(19) United States
(12) Patent Application Publication
(10) Pub. No.: US 2014/0271390 A1
(43) Pub. Date: Sep. 18, 2014

(54) ZPGM Catalyst Systems and Methods of Making Same

(71) Applicant: Zahra Nazarpoor, Camarillo, CA (US)

(72) Inventor: Zahra Nazarpoor, Camarillo, CA (US)

(73) Assignee: CDTI, Ventura, CA (US)

(21) Appl. No.: 13/849,185

(22) Filed: Mar. 22, 2013

Related U.S. Application Data
(60) Provisional application No. 61/792,071, filed on Mar. 15, 2013.

(51) Int. Cl. B01D 53/94; B01J 23/889; B01J 23/89; B01J 23/34

(52) U.S. Cl. CPC B01D 53/945; B01J 23/34; B01J 23/8892; B01J 23/8986
USPC 422/177; 502/324; 502/304; 502/303

(57) ABSTRACT

Described are ZPGM catalyst systems which are free of any platinum group metals for reducing emissions of carbon monoxide, nitrogen oxides, and hydrocarbons in exhaust streams. ZPGM catalyst systems may include a substrate, a washcoat, and an overcoat. Both manganese and copper may be provided as catalysts, with copper in the overcoat and manganese preferably in the washcoat. The manganese can also be provided in the overcoat, but when in the overcoat should be stabilized for greatest effectiveness. A carrier material oxide may be included in both washcoat and overcoat. It has been discovered that the ZPGM catalyst systems are effective even without OSM in washcoat and the ZPGM catalysts within washcoat and overcoat may be best prepared by co-milling an aqueous slurry that includes manganese with alumina for the washcoat and copper and cerium salts with alumina and an OSM, for overcoat prior to overcoating and heat treating. Disclosed ZPGM TWC systems in catalytic converters may be employed to decrease the pollution caused by exhaust from various sources, such as automobiles, utility plants, processing and manufacturing plants, airplanes, trains, all-terrain vehicles, boats, mining equipment, and other engine-equipped machines.

### CROSS-REFERENCE TO RELATED APPLICATIONS

The present application claims priority to U.S. Provisional Application No. 61/792,071, entitled ZPGM Catalyst Systems and Methods of Making Same, filed Mar. 15, 2013, and is related to U.S. patent application Ser. No. 12/229,792, entitled Zero Platinum Group Metal Catalysts, filed Aug. 26, 2008, and U.S. patent application Ser. No. 12/791,699, entitled Zero Platinum Group Metal Catalysts, filed Jun. 1, 2010, the entireties of which are incorporated herein by reference.

### BACKGROUND

1. Field of the Disclosure

The present disclosure relates generally catalyst systems, and more particularly to compositions and methods for the preparation of Zero Platinum Group Metal (ZPGM) TWC systems.

2. Background

Catalysts in catalytic converters have been used to decrease the pollution caused by exhaust from various sources, such as automobiles, utility plants, processing and manufacturing plants, airplanes, trains, all-terrain vehicles, boats, mining equipment, and other engine-equipped machines. Important pollutants in the exhaust gas of engines may include carbon monoxide (CO), unburned hydrocarbons (HC), nitrogen oxides (NOx), and particulate matter (PM). Common three way catalysts (TWC) may work by converting carbon monoxide, hydrocarbons and nitrogen oxides into less harmful compounds or pollutants.

TWC within catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters.

For the foregoing reasons, there is a need for improved TWC systems that do not require PGM and that may exhibit similar or better efficiency than prior art TWC catalysts.

### SUMMARY OF THE INVENTION

The present disclosure pertains to composition of ZPGM TWC systems including a substrate, a washcoat and an overcoat, which includes copper, cerium and manganese catalysts in combinations that are substantially free of platinum group metals.

The present disclosure also pertains to a method of making ZPGM TWC catalyst systems including a substrate, a washcoat and an overcoat, where the ZPGM TWC catalyst system includes copper, cerium and manganese catalysts in combinations that are substantially free of platinum group metals.

In addition, washcoat and/or overcoat of disclosed ZPGM TWC systems may include carrier material oxide and/or oxygen storage material (OSM). Suitable carrier material oxide may include pure Al₂O₃, doped Al₂O₃, Ti₁₋ₓNbxO₂, TiO₂, SiO₂, ZeO₂, among others. Furthermore, suitable OSM may be a mixture of ceria, zirconia, and lanthanum or (2) ceria, zirconia, neodymium, and praseodymium,

Other preferred aspects and their advantages are set out in the description which follows.

The disclosed ZPGM TWC catalyst systems may be employed within catalytic converters. ZPGM TWC systems of the present disclosure may include high surface area, low conversion temperature catalysts that may convert toxic exhaust gas into less harmful compounds.

### BRIEF DESCRIPTION OF THE DRAWINGS

Embodiments of the present disclosure are described by way of example with reference to the accompanying figures. which are schematic and are not intended to be drawn to scale.

FIG. 1 compares the HC, CO and NO light-off results of “Type 2” and “Type 4” ZPGM catalyst systems.

FIG. 2 compares the HC, CO and NO light-off results of “Type 1” and “Type 3” ZPGM catalyst systems.

FIG. 3 shows the light-off test results for “Type 3” and “Type 8” ZPGM catalyst systems.

FIG. 4 shows the light-off test results of Mn loading in “Type 9” ZPGM catalyst systems.

FIG. 5 shows the light-off test results for “Type 3” ZPGM catalyst systems.

### DETAILED DESCRIPTION

The present disclosure is hereby described in detail with reference to embodiments illustrated in the drawings, which form a part hereof. Other embodiments may be used and/or and other changes may be made without departing from the spirit or scope of the present disclosure. The illustrative embodiments described in the detailed description are not meant to be limiting of the subject matter presented herein.

### DEFINITIONS

As used herein, the following terms have the following definitions:

“Catalyst system” refers to a system of at least two layers including at least one substrate, a washcoat, and/or an overcoat.

“Substrate” refers to any suitable material for supporting a catalyst and can be of any shape or configuration that yields a sufficient surface area for the deposition of a washcoat.

“Washcoat” refers to at least one coating including at least one oxide solid that may be deposited on a substrate.

“Overcoat” refers to at least one coating including one or more oxide solid that may be deposited on at least one washcoat.

“Oxide solid” refers to any mixture of materials selected from the group including a carrier material oxide, a catalyst, and a mixture thereof.

“Carrier material oxide” refers to materials used for providing a surface for at least one catalyst.

“Oxygen storage material” refers to materials that can take up oxygen from oxygen-rich feed streams and release oxygen to oxygen-deficient feed streams.

“Three-Way Catalyst” refers to a catalyst that may achieve three simultaneous tasks: reduce nitrogen oxides to nitrogen and oxygen, oxidize carbon monoxide to carbon dioxide and oxidize unburnt hydrocarbons to carbon dioxide and water.

“ZPGM Transition Metal Catalyst” refers to at least one catalyst that includes at least one transition metal that is completely free of platinum group metals.

“Impregnation component” refers to at least one component added to a washcoat and/or overcoat to yield a washcoat and/or overcoat including at least one catalyst.

“Platinum group metals” refers to platinum, palladium, ruthenium, iridium, osmium, and rhodium.

“Treating,” “treated,” or “treatment” refers to precipitation, drying, firing, heating, evaporating, calcining, or mixtures thereof.

“Exhaust” refers to the discharge of gases, vapor, and fumes created by and released at the end of a process, including hydrocarbons, nitrogen oxide, and/or carbon monoxide.

“Conversion” refers to the change from harmful compounds (such as hydrocarbons, carbon monoxide, and nitrogen oxide) into less harmful and/or harmless compounds (such as water, carbon dioxide, and nitrogen).

“R Value” refers to the number obtained by dividing the reducing potential by the oxidizing potential.

“Rich Exhaust” refers to exhaust with an R value above 1.

“Lean Exhaust” refers to exhaust with an R value below 1.

### Description of Drawings

Compositions and methods for preparation of ZPGM TWC systems are disclosed. Disclosed ZPGM TWC systems may include at least one ZPGM catalyst.

### Catalyst System Structure

The ZPGM TWC system of the present disclosure may include a substrate, a washcoat, and an overcoat. Both manganese and copper are provided as catalysts, with copper in the overcoat and manganese preferably in the washcoat. The manganese may also be provided in the overcoat, but when in the overcoat, stabilization may be needed for greatest effectiveness. Other components known to one of ordinary skill in the art may be included. For example, an OSM may be employed, but the catalysts of the present disclosure are found to function well as oxidation/reduction catalysts without an OSM. When an OSM is present, OSM is preferably in the overcoat rather than on the washcoat.

The ZPGM TWC system can also include one or more mixed metal oxide catalysts, one or more zeolite catalysts, one or more OSM's, and one or more carrier material oxides, such as alumina, in the overcoat and/or the washcoat.

In the preparation of a ZPGM TWC system including a substrate, a washcoat and an overcoat, the washcoat may be deposited in two different ways. First, depositing all desired components in one step as washcoat. Or second, depositing components without a catalyst, then separately depositing at least one impregnation component and heating (this separate deposit is also referred to as an impregnation step). The impregnation component may include transition metals, alkali and alkaline earth metals, cerium, lanthanum, yttrium, samarium, lanthanides, actinides, or mixtures thereof. The impregnation step converts metal salts (such as nitrate, acetate or chloride) into metal oxides creating a washcoat including at least one catalyst. An overcoat is typically applied after treating the washcoat, but treating is not required prior to application of the overcoat in every embodiment. Preferably, an overcoat is applied after the washcoat.

### Substrates

The substrate of the present disclosure may be a refractive material, a ceramic substrate, a honeycomb structure, a metallic substrate, a ceramic foam, a metallic foam, a reticulated foam, or suitable combinations, where the substrate has a plurality of channels and at least the required porosity. Porosity is substrate dependent as is known in the art. Additionally, the number of channels may vary depending upon the substrate used as is known in the art. The type and shape of a suitable substrate would be apparent to one of ordinary skill in the art. Preferably, all of the substrates, either metallic or ceramic, offer a three-dimensional support structure. In one embodiment, the substrate may be in the form of beads or pellets. The beads or pellets may be formed from alumina, silica alumina, silica, titania, mixtures thereof, or any suitable material.

In another embodiment, the substrate may be a honeycomb substrate. The honeycomb substrate may be a ceramic honeycomb substrate or a metal honeycomb substrate. The ceramic honeycomb substrate may be formed from, for example sillimanite, zirconia, petalite, spodumene (lithium aluminum silicate), magnesium silicates, mullite, alumina, cordierite (e.g. Mg₂A1₄Si₅O₁₈), other alumina-silicate materials, silicon carbide, aluminum nitride, or combinations thereof. Other ceramic substrates would be apparent to one of ordinary skill in the art. If the substrate is a metal honeycomb substrate, the metal may be a heat-resistant base metal alloy, particularly an alloy in which iron is a substantial or major component. The surface of the metal substrate may be oxidized at elevated temperatures above about 1000° C. to improve the corrosion resistance of the alloy by forming an oxide layer on the surface of the alloy. This oxide layer on the surface of the alloy may also enhance the adherence of a washcoat to the surface of the monolith substrate.

In one embodiment, the substrate may be a monolithic carrier having a plurality of fine, parallel flow passages extending through the monolith. The passages can be of any suitable cross-sectional shape and/or size. The passages may be, for example trapezoidal, rectangular, square, sinusoidal, hexagonal, oval, or circular, although other shapes are also suitable. The monolith may contain from about 9 to about 1200 or more gas inlet openings or passages per square inch of cross section, although fewer passages may be used. The substrate can also be any suitable filter for particulates. Some suitable forms of substrates may include woven filters, particularly woven ceramic fiber filters, wire meshes, disk filters, ceramic honeycomb monoliths, ceramic or metallic foams, wall flow filters, and other suitable filters. Wall flow filters are similar to honeycomb substrates for automobile exhaust gas catalysts. They may differ from the honeycomb substrate that may be used to form normal automobile exhaust gas catalysts in that the channels of the wall flow filter may be alternately plugged at an inlet and an outlet so that the exhaust gas is forced to flow through the porous walls of the wall flow filter while traveling from the inlet to the outlet of the wall flow filter.

### Washcoats

The washcoat for a ZPGM catalyst system of the present disclosure may include amounts of carrier material oxide, ZPGM catalyst and OSM in order to achieve the objective of oxidizing hydrocarbons and carbon monoxide in an oxygen-rich exhaust and reducing NOX in fuel/rich exhaust. In some forms, the washcoat may include from about 40 to about 80% of at least one carrier material oxide, from about 2 to about 20% of one or more transition metal catalysts (as oxides) and from about 0 to about 60% of at least one OSM. More suitable, the washcoat may include from about 40 to about 60% of at least one carrier material oxide, from about 5% to about 10% of one or more transition metal catalysts and from about 0 to about 30% of at least one OSM. The manganese oxide is preferably placed in the washcoat.

According to an embodiment, at least a portion of the manganese oxide and copper oxide and other catalysts employed according to the present disclosure may be placed on the substrate in the form of a washcoat. Optional transition metal oxides and rare earth metals, e.g., ceria, may also be applied. The oxide solids in the washcoat may be one or more carrier material oxide, one or more catalysts, or a mixture of carrier material oxide(s) and catalyst(s), and optionally one or more OSM. Carrier material oxides are normally stable at high temperatures (>1000° C.) and under a range of reducing and oxidizing conditions. Suitable OSM may be a mixture of ceria and zirconia; more suitable a mixture of (1) ceria, zirconia, and lanthanum or (2) ceria, zirconia, neodymium, and praseodymium. Various amounts of any of the washcoats of the present disclosure may be coupled with a substrate, preferably an amount that covers most of, or all of, the surface area of a substrate. In an embodiment, about 60 g/L to about 250 g/L of a washcoat may be coupled with a substrate.

In an embodiment, a washcoat may be formed on the substrate by suspending the oxide solids in water to form an aqueous slurry and depositing the aqueous slurry on the substrate as a washcoat. Other components may optionally be added to the aqueous slurry. Other components such as acid or base solutions or various salts or organic compounds may be added to the aqueous slurry to adjust the rheology of the slurry and/or to enhance the adhesion of washcoat to the substrate. Some examples of compounds that can be used to adjust the rheology include ammonium hydroxide, aluminum hydroxide, acetic acid, citric acid, tetraethylammonium hydroxide, other tetraalkylammonium salts, ammonium acetate, ammonium citrate, glycerol, commercial polymers such as polyethylene glycol, polyvinyl alcohol and other suitable polymers. The slurry may be placed on the substrate in any suitable manner. For example, the substrate may be dipped into the slurry, or the slurry may be sprayed on the substrate. Other methods of depositing the slurry onto the substrate known to those skilled in the art may be used in alternative embodiments. If the substrate is a monolithic carrier with parallel flow passages, the washcoat may be formed on the walls of the passages. Gas flowing through the flow passages can contact the washcoat on the walls of the passages as well as materials that are supported on the washcoat.

### Overcoats

The overcoats for a ZPGM catalyst system of the present disclosure may include amounts of carrier material oxide, ZPGM catalyst and OSM in order to achieve the objective of oxidizing/reducing hydrocarbons, carbon monoxide and nitrogen oxide in an oxygen/fuel-rich exhaust. In some forms, the overcoat may include from about 40 to about 80% of at least one carrier material oxide, from about 2 to about 50% of one or more transition metal catalysts (as oxides) and from about 0 to about 60% of at least one OSM. Preferably, the overcoat may include from about 40 to about 60% of at least one carrier material oxide, from about 5 to about 10% of one or more transition metal catalysts and from about 0 to about 40% of at least one OSM. In an embodiment, the alumina and OSM of the overcoat may be present in the overcoat in a ratio of about 60 to about 40. And, copper and cerium in the overcoat may be present in about 5% to about 50%, preferably about 10% to 16% by weight of Cu and 12% to 20% by weight of Ce. Heat treating may be done at a temperature between 300° C. and 700° C., more suitable about 550° C. and may last from about 2 to about 6 hours, more suitable about 4 hours for washcoat and overcoat.

The manganese oxide is preferably placed in the washcoat, but can be included in the overcoat when properly stabilized. For example, a manganese salt can be dissolved in stabilizer solution with a suitable stabilizer such as polyethylene glycol, polyvinyl alcohol, poly(N-vinyl-2pyrrolidone)(PVP), olyacrylonitrile, polyacrylic acid, multilayer polyelectrolyte films, polysiloxane,

oligosaccharides, poly(4-vinylpyridine), poly(N,N-dialkylcarbodiimide), chitosan, hyper branched aromatic polyamides and other suitable polymers. The stabilized transition metal solution, such as manganese solution, can be then be deposited on the washcoat as impregnation step and the resulting composite may be heat treated for about 2 hours to about 6 hours, more suitable for about 4 hours and at a temperature of 300° C. to about 700° C., more suitable about 550° C. A carrier material oxide in the overcoat preferably includes alumina doped with lanthanum. It has been discovered that the ZPGM catalyst systems are also effective without OSM in overcoat and the copper may be best prepared by co-milling an aqueous slurry including copper and cerium salts (such as nitrate, acetate or chloride) with alumina and an OSM prior to overcoating and heat treating. An overcoat including copper oxide and ceria discussed here may be prepared by different methods. A preferred method may be co-milling the copper and ceria with overcoat. The copper salt and cerium salt are milled together with the carrier material oxide including alumina and at least one OSM and then deposited on a pre-washcoated substrate in the form of an overcoat. Next, the substrate with overcoat is heat treated from 2 hours to about 6 hours, more suitable for about 4 hours at a temperature of about 300° C. to about 700° C., more suitable temperature may be of about 550° C.

According to an embodiment, the overcoat may include at least one transition metal catalyst including at least copper oxide. Optional transition metal oxides and rare earth metals, e.g., ceria, can also be applied. Overcoat may also include at least a portion of the manganese oxide and other catalysts employed according to the present disclosure. As with the washcoat, the oxide solids in the washcoat may be one or more carrier material oxide, one or more catalysts, or a mixture of carrier material oxide(s) and catalyst(s), and optionally one or more OSMs. Carrier material oxides are normally stable at high temperatures (>1000° C.) and under a range of reducing and oxidizing conditions. A suitable OSM may be a mixture of ceria and zirconia; more suitable OSM may be a mixture of (1) ceria, zirconia, and lanthanum or (2) ceria, zirconia, neodymium, and praseodymium. Various amounts of any of the overcoats of the present disclosure may be coupled with a washcoat, preferably an amount that covers most of, or all of, the surface area of a washcoat. In an embodiment, about 60 g/L to about 250 g/L of an overcoat may be coupled with a washcoat.

In an embodiment, an overcoat may be formed on the washcoat by suspending the oxide solids in water to form an aqueous slurry and depositing the aqueous slurry on the substrate as an overcoat. Other components may optionally be added to the aqueous slurry. Other components such as acid or base solutions or various salts or organic compounds may be added to the aqueous slurry to adjust the rheology of the slurry and/or enhance binding of the washcoat to the substrate. Some examples of compounds that can be used to adjust the rheology may include ammonium hydroxide, aluminum hydroxide, acetic acid, citric acid, tetraethylammonium hydroxide, other tetraalkylammonium salts, ammonium acetate, ammonium citrate, glycerol, commercial polymers such as polyethylene glycol, polyvinyl alcohol and other suitable polymers.

The slurry may be placed on the washcoat in any suitable manner. For example, the substrate may be dipped into the slurry, or the slurry may be sprayed on the washcoat. Other methods of depositing the slurry onto the substrate known to those skilled in the art may be used in alternative embodiments. If the substrate is a monolithic carrier with parallel flow passages, the washcoat and the overcoat may be formed on the walls of the passages. Gas flowing through the flow passages can contact the overcoat on the walls of the passages as well as materials that are supported on the washcoat.

### ZPGM Transition Metal Catalyst

According to an embodiment, a ZPGM catalyst system of the present disclosure includes a ZPGM transition metal catalyst including at least manganese oxide and copper oxide distributed between the washcoat and the overcoat. A ZPGM transition metal catalyst includes oxides of one or more transition metals. Preferably the transition metals in addition to copper and manganese are nickel, iron, manganese, cobalt, tungsten, niobium, molybdenum, or chromium, and of these, manganese, nickel, iron, silver and cobalt are preferred in some ZPGM catalyst systems. Optional transition metal oxides and rare earth metals, such as ceria, may also be employed.

According to an embodiment, the ZPGM transition metal catalyst optionally includes one or more of a carrier material oxide. Preferably the catalyst includes a perovskite, a spinel, a lyonsite, an OSM, alumina, or mixtures thereof; more preferably a spinel, an OSM, alumina, or mixtures thereof; most preferably at least one spinel and at least one OSM, or alumina and at least one OSM. Alumina is a preferred carrier material oxide. Alumina can be free of lanthanum or doped with lanthanum in the amount of 0% to 10% by weight La.

Other embodiments may include carrier material oxides such as: Ti₁₋ₓNbO₂, TiO₂, SiO₂, doped Al₂O₃, ZeO₂, among others.

### Mixed Metal Oxide Catalyst

According to an embodiment, a catalyst may be a mixed ZPGM metal oxide catalyst, which includes at least one transition metal and at least one other metal. The other metals of the mixed metal oxide may include alkali and alkaline earth metal, lanthanides, or actinides. For example, the mixed metal oxide may be a spinel, a perovskite, a delafossite, a lyonsite, a garnet, or a pyrochlore.

According to an embodiment, a catalyst, may include a perovskite having the formula ABO₃ or a related structure with the general formula A1-xMXBO3 from partial substitution of site A of ABO3 perovskite. And partial substitution of site B with element M which will be AB1-xMxO3. “A” may include lanthanum, lanthanides, actinides, cerium, magnesium, calcium, barium, strontium, or mixtures thereof. “B” may include a single transition metal, or a mixture of transition metals and rare earth metals including iron, manganese, copper, nickel, cobalt, and cerium, or mixture thereof. According to an embodiment, the catalyst may have the formula AMn₁₋ₓCuₓO₃, where “A” may be lanthanum, cerium, barium, strontium, a lanthanide, or an actinide and “x” is 0 to 1.

According to another embodiment, a catalyst may have the formula ACe₁₋ₓCuₓO₃, where “A” may be manganese, and “x” is 0 to 1. According to an embodiment, about 10 g/L to about 180 g/L of the formula ABO₃ may be coupled with the substrate. According to one embodiment, a catalyst includes a perovskite (ABO₃) or related structure (with general formula Aₐ₋ₓBₓMO_{b}) and one or more of a carrier material oxide. The perovskite or related structure is present in about 5% to about 50% by weight. According to an embodiment, a catalyst includes a spinel having the formula AB₂O₄. “A” and “B” of the formula may be aluminum, magnesium, manganese, gallium, nickel, copper, cobalt, molybdenum, vanadium, iron, chromium, titanium, tin, or mixtures thereof. According to an embodiment, A or B is manganese, (e.g. CuMn₂O₄).

According to an embodiment, a catalyst includes a spinel and a carrier material oxide. The spinel is present in about 5% to about 50% by weight. According to an embodiment, a catalyst may be a zeolite catalyst including a zeolite or mixture of zeolites and at least one transition metal. A zeolite may be mixed alumino silicates with regular interconnected pores. The zeolite includes ZSM5, heulandite, chabazite, or mixtures thereof, preferably ZSM5. According to an embodiment, a catalyst includes at least one transition metal impregnated into a zeolite or mixtures of zeolite. The transition metal(s) may be a single transition metal or a mixture of transition metal which includes chromium, gallium, manganese, iron, cobalt, nickel, copper, niobium, molybdenum, tungsten, vanadium and silver. Preferably, the transition metals are selected from the group including copper, chromium, nickel, iron, cobalt, vanadium, molybdenum, and mixtures thereof. The transition metals may be present in about 3% to about 25% by weight in any ratio of transition metals.

### Preparation of a Zero Platinum Group Metal Catalyst by Impregnation

A washcoat having the properties discussed here may be prepared by methods well known in the art. The washcoat may include any of the ZPGM catalysts and/or additional components described here. The washcoat may be deposited on a substrate and may be treated. The treating may be done at a temperature between 300° C. and 700° C., preferably about 550° C. The treating may last from about 2 to about 6 hours, preferably about 4 hours. After the washcoat and the substrate are treated, washcoat may be cooled to about room temperature. After the washcoat and the substrate are cooled, the washcoat may be impregnated with at least one impregnation component. The impregnation component may include a transition-metal salt or salts being dissolved in water and impregnated on the washcoat. Following the impregnation step, the washcoat with the impregnation components may be treated. The treating may be performed at about 300° C. to about 700° C., preferably about 550° C. The treating may last from about 2 to about 6 hours, preferably about 4 hours.

According to an embodiment, the substrate, the washcoat, and the impregnation components may be treated to form the catalyst composition before or after the washcoat and/or the impregnation components may be added to the substrate. In an embodiment, the washcoat and the impregnation component may be treated before coating. After depositing the overcoat, the overcoat may be treated. The treating may be performed at about 300° C. to about 700° C., preferably about 550° C. The treating may last from about 2 hours to about 6 hours, preferably about 4 hours.

### Preparation of a Zero Platinum Group Metal Catalyst by Co-Precipitation

The method of co-precipitation may include precipitating a transition metal salt or salts on a washcoat. The transition metal salt or salts may be precipitated with NH₄OH, (NH₄)₂CO₃, tetraethylammonium hydroxide, other tetraalkylammonium salts, ammonium acetate, or ammonium citrate. The washcoat may be any washcoat described here. Next, the precipitated transition metal salt or salts and washcoat may be aged at room temperature for 2 to 72 hours, more suitable for about 5 to 24 hours. Next, the precipitated transition metal salt or salts and the washcoat may be deposited on a substrate followed by heat treating for about 2 hours to about 6 hours, preferably about 4 hours at a temperature of about 300° C. to about 700° C., preferably about 550° C. Optionally, after treating, an overcoat may be deposited on the treated precipitated transition metal salt or salts and washcoat and treated again. The overcoat may be treated for about 2 hours to about 6 hours, preferably about 4 hours and at a temperature of about 300° C. to about 700° C., preferably about 550° C.

### Preparation of a Zero Platinum Group Metal Catalyst by Co-Milling

In order to prepare a ZPGM catalyst employing co-milling method, a catalyst and a carrier material oxide may be milled together. The catalyst can be synthesized by any chemical technique such as solid-state synthesis, precipitation, or any other technique known in the art. The milled catalyst and carrier material oxide may be deposited on a substrate in the form of a washcoat and then treated. The treatment may be from about 2 hours to about 6 hours, preferably about 4 hours and at a temperature of about 300° C. to about 700° C., preferably about 550° C. Optionally, an overcoat may be deposited on the treated catalyst after cooling to about room temperature. The overcoat, washcoat and substrate may be treated for about 2 hours to about 6 hours, preferably about 4 hours and at a temperature of 300° C. to about 700° C., preferably about 550° C.

The following examples are intended to illustrate the scope of the disclosure. It is to be understood that other procedures known to those skilled in the art may alternatively be used.

### EXAMPLES

### Example 1

Example 1 shows the possible synergy between Mn and Ag, and between Mn and Cu—Ce as ZPGM catalysts for oxidizing hydrocarbons and carbon monoxide; as well as for reducing nitrogen oxides. A ZPGM catalyst system of the present disclosure includes a ZPGM transition metal catalyst. A ZPGM transition metal catalyst includes one or more ZPGM transition metals including copper and manganese. The ZPGM transition metal catalyst may include one or more of a carrier material oxide more preferably a spinel, an OSM, alumina or mixtures thereof.

A ZPGM TWC catalyst system, referred to “Type 1”, includes a substrate, a washcoat and an overcoat. The washcoat may include alumina and at least one OSM, preferably the OSM is a mixture of cerium and zirconium. Additionally, the OSM and the alumina may be present in the washcoat in a ratio of 40 to about 60 by weight. The washcoat does not include transition metal catalyst. The overcoat may include copper oxide, ceria, alumina, and at least one OSM, preferably the OSM includes a mixture of cerium, zirconium, neodymium, and praseodymium. The alumina and OSM of the overcoat may be present in the overcoat in a ratio of about 60 to about 40. The copper and cerium in the overcoat are present in about 5% to about 50%, preferably about 10% to 16% by weight of Cu and 12% to 20% by weight of Ce. The heat treating may be done at a temperature between 300° C. and 700° C., preferably about 550° C. The heat treating may last from about 2 to about 6 hours, preferably about 4 hours for washcoat and overcoat.

A ZPGM TWC system, referred to “Type 2”, includes a substrate, a washcoat and an overcoat. The washcoat may include alumina and a ZPGM catalyst, such as silver. The alumina may be present in the washcoat in a ratio of 40 to about 60 by weight. The silver in the washcoat may be present in about 1% to about 20%, preferably about 4% to about 10% by weight. The overcoat may include copper oxide, ceria, alumina, and at least one OSM, preferably the OSM includes a mixture of cerium, zirconium, neodymium, and praseodymium. The lanthanum doped alumina and OSM of the overcoat may be present in the overcoat in a ratio of about 60 to about 40. The copper and cerium in the overcoat may be present in about 5% to about 50%, preferably about 10% to 16% by weight of Cu and 12% to 20% by weight of Ce. The heat treating may be done at a temperature between 300° C. and 700° C., preferably about 550° C. The heat treating may last from about 2 to about 6 hours, preferably about 4 hours for washcoat and overcoat.

A ZPGM catalyst system, referred to “Type 3”, includes a substrate, washcoat and an overcoat. The substrate may include cordierite. The washcoat may include lanthanum doped alumina and a ZPGM transition metal, such as manganese. The doped alumina may be present in the washcoat in a ratio of 40 to about 60 by weight. Manganese and a carrier material oxide may be milled together. The ZPGM catalyst may be synthesized by any chemical technique such as solid-state synthesis, precipitation, or any other technique known in the art. The milled ZPGM catalyst and carrier material oxide may be deposited on a substrate in the form of a washcoat and then heat treated. The manganese in the washcoat may be present in about 1% to about 20%, preferably about 4% to about 10% by weight. The overcoat may include copper oxide, ceria, alumina, and at least one OSM; preferably the OSM includes a mixture of cerium, zirconium, neodymium, and praseodymium. The alumina (lanthanum doped alumina) and OSM of the overcoat may be present in the overcoat in a ratio of about 60 to about 40. The copper and cerium in the overcoat may be present in about 5% to about 50%, preferably about 10% to 16% by weight of Cu and 12% to 20% by weight of Ce. The heat treating, for both the washcoat and overcoat, may be done at a temperature between 300° C. and 700° C., preferably about 550° C. The heat treating may last from about 2 to about 6 ours, preferably about 4 hours for washcoat and overcoat.

A ZPGM TWC system, referred to “Type 4”, includes a substrate, a washcoat and an overcoat. The washcoat may include alumina and a ZPGM catalyst, such as silver. No OSM is included in the washcoat. The alumina may be present in the washcoat in a ratio of 40 to about 60 by weight. The silver in the washcoat may be present in about 1% to about 20%, preferably about 4% to about 10% by weight. The overcoat may include a ZPGM catalyst, such as manganese, and alumina. The manganese in the overcoat may be present in about 1% to about 20%, preferably about 4% to about 10% by weight. No OSM is included in the overcoat. The heat treating, for both the washcoat and the overcoat, may be done at a temperature between 300° C. and 700° C., preferably about 550° C. The heat treating may last from about 2 to about 6 hours, preferably about 4 hours for washcoat and overcoat.

FIG. 1 compares the HC, CO and NO light-off results of “Type 2” and “Type 4” ZPGM catalyst systems 100. It should be noted that “Type 2” and “Type 4” catalysts systems are aged under dry air condition at 900° C. for 4 hours. A light-off test is performed on aged “Type 2” and “Type 4” ZPGM catalyst systems. The test may be performed by increasing the temperature from about 100° C. to 580° C. The light-off test measures the conversions of carbon monoxide, nitrogen oxides and hydrocarbons as a function of the ZPGM catalyst system temperature. For a specific temperature, a higher conversion signifies a more efficient catalyst. Conversely, for a specific conversion, a lower temperature signifies a more efficient catalyst. It should be noted that the hydrocarbon of feed stream is propylene (also known as propene C₃H₆) under rich condition with R-value=1.224.

The “Type 4” ZPGM catalyst system which includes transition metals such as silver and manganese, in washcoat and overcoat, respectively, exhibits a lower CO conversion compared to ZPGM “Type 2”, that does not include Mn. In addition, The ZPGM “Type 4” catalyst system does not show any measured NO conversion up to 580° C. Therefore FIG. 2 results show that there is no synergy between Mn and Ag.

FIG. 2 compares the HC, CO and NO light-off results of “Type 1” and “Type 3” ZPGM catalyst system 200. The light off results shows that “type 3” ZPGM catalyst system, which includes Mn catalyst in washcoat has great oxidation and reduction activities compare to Type 1 which does not have Mn in washcoat. The ZPGM “Type 3” catalyst system which includes manganese in washcoat improves the catalyst performance of ZPGM “Type 1” up to 165° C. for the HC conversion and up to 80° C. for the NOx conversion. FIG. 2 results show the presence of synergetic effect between Mn and Cu—Ce.

### Example 2

Example 2 shows different types of ZPGM catalysts that may be produced employing different processes of adding the manganese catalyst.

Co-Precipitation of Mn

A washcoat including the transition metal such as manganese may be prepared by methods well known in the art. The method of co-precipitation includes precipitating the transition metal salt on a washcoat. The transition metal salt may be precipitated with NH₄OH,(NH₄)₂CO₃, tetraethylammonium hydroxide, other tetraalkylammonium salts, ammonium acetate, ammonium carbonate or ammonium citrate. The washcoat may be any washcoat described here. Next, the precipitated transition metal salt or salts and the washcoat may be deposited on a substrate followed by heat treating for about 2 hours to about 6 hours, preferably about 4 hours at a temperature of about 300° C. to about 700° C., preferably about 550° C. Optionally, after heat treating, an overcoat may be deposited on the treated precipitated transition metal salt and washcoat and heat treated again. The overcoat may be treated for about 2 hours to about 6 hours, preferably about 4 hours and at a temperature of about 300° C. to about 700° C., preferably about 550° C. The co-precipitation of transition metal may be performed on an overcoat. The overcoat may be any overcoat described here. Next, the precipitated transition metal salt and overcoat are heat treated. The heat treating may be from about 2 hours to about 24 hours.

“Type 5” ZPGM catalyst system is an example of co-precipitation of Mn salt in washcoat. A ZPGM TWC system, referred to “Type 5”, includes a substrate, a washcoat and an overcoat. The washcoat may include a ZPGM catalyst, alumina and at least one OSM, preferably the OSM is a mixture of cerium and zirconium. Additionally, the OSM and the alumina may be present in the washcoat in a ratio of 40 to about 60 by weight. The overcoat may include a group of transition metals, ceria, alumina, and at least one OSM, preferably the OSM includes a mixture of cerium, zirconium, neodymium, and praseodymium. The alumina and OSM of the overcoat may be present in the overcoat in a ratio of about 60 to about 40. The ZPGM transition metals include copper and manganese. Copper in the overcoat may be present in about 5% to about 50%, preferably about 10% to about 16% by weight and manganese in washcoat may be present in about 1% to about 20%, preferably about 4% to about 10% by weight. Ceria in overcoat may be present in about 5% to about 50%, preferably about 12% to 20% by weight. Following the washcoat and overcoat steps, the substrates may be heat treated. The heat treating may be performed at about 300° C. to about 700° C., preferably about 550° C. The heat treating may last from about 2 to about 6 hours, preferably about 4 hours.

### Impregnation of Mn

“Type 6” ZPGM catalyst system is an example of impregnation of Mn in washcoat. The washcoat may include carrier oxide materials and/or at least one oxygen storage material. The washcoat may be deposited on a substrate and may be heat treated. The heat treating may be done at a temperature between 300° C. and 700° C., preferably about 550° C. The heat treating may last from about 2 to about 6 hours, preferably about 4 hours. After the washcoat and the substrate are treated, washcoat and substrate may be cooled to about room temperature. After the washcoat and the substrate are cooled, the washcoat may be impregnated with at least one impregnation component such as manganese. The impregnation component may include a transition-metal salt being dissolved in water and impregnated on the washcoat. Following the impregnation step, the washcoat with the impregnation components may be heat treated. The heat treating may be performed at about 300° C. to about 700° C., preferably about 550° C. The heat treating may last from about 2 to about 6 hours, preferably about 4 hours. According to an embodiment, the substrate, the washcoat, and the impregnation components may be treated to form the ZPGM catalyst composition before or after the washcoat and/or the impregnation components are added to the substrate. In an embodiment, the washcoat and the impregnation component may be heat treated before coating.

### Co-Milling of Mn

A ZPGM transition metal such as Mn and a carrier material oxide may be milled together. The milled ZPGM catalyst and carrier material oxide may be deposited on a substrate in the form of a washcoat and then heat treated. The heat treatment may be from about 2 hours to about 6 hours, preferably about 4 hours and at a temperature of about 300° C. to about 700° C., preferably about 550° C. Optionally, an overcoat may be deposited on the treated ZPGM catalyst after cooling to about room temperature. The overcoat, washcoat and substrate may be heat treated for about 2 hours to about 6 hours, preferably about 4 hours and at a temperature of 300° C. to about 700° C., preferably about 550° C. “Type 3” ZPGM catalyst system is an example of the co-milling Mn in washcoat.

### Stabilization of Mn

The stabilized metal particles may include a transition-metal salt being dissolved in stabilizer solution. Some examples of compounds that can be used to stabilize the transition metal ions may include polyethylene glycol, polyvinyl alcohol, poly(N-vinyl-2pyrrolidone)(PVP), polyacrylonitrile, polyacrylic acid, multilayer polyelectrolyte films, poly-siloxane, oligosaccharides, poly(4-vinylpyridine), poly(N,Ndialkylcarbodiimide), chitosan, hyper-branched aromatic polyamides and other suitable polymers. The stabilized transition metal solution can be then impregnated on the substrate that already washcoated, or co-milled with carrier material oxide together and deposited on substrate as washcoat. The washcoat and substrate may heat treated for about 2 hours to about 6 hours, preferably about 4 hours and at a temperature of 300° C. to about 700° C., preferably about 550° C. “Type 7” ZPGM catalyst system is an example of stabilizing of Mn in washcoat. A ZPGM catalyst system, referred to “Type 7”, may include a substrate, a washcoat and an overcoat. The washcoat includes alumina and at least one OSM, preferably the OSM is a mixture of cerium and zirconium. Additionally, the OSM and the alumina may be present in the washcoat in a ratio of 40 to about 60 by weight. A transition metal such as manganese salt dissolved in a stabilizer discussed here with the ratio Ag to stabilizer of 0.1 to 5 by weight, preferably about 0.5 to 1. The Mn stabilized solution and a carrier material oxide are milled together and may be deposited on substrate as washcoat. Manganese in washcoat may be present in about 1% to about 20%, preferably about 4% to about 10% by weight. The overcoat may include a group of transition metals, ceria, alumina, and at least one OSM, preferably the OSM may include a mixture of cerium, zirconium, neodymium, and praseodymium. The alumina and OSM of the overcoat may be present in the overcoat in a ratio of about 60 to 40. The transition metals in the overcoat may include copper and may be present in about 5% to 50%, preferably about 10% to about 16% by weight. Ceria in overcoat may be present in about 5% to 50%, preferably about 12% to 20% by weight. Following the washcoat and overcoat steps, the substrates may be heat treated. The heat treating may be performed at about 300° C. to about 700° C., preferably about 550° C. The heat treating may last from about 2 to about 6 hours, preferably about 4 hours.

### Example 4

Example 4 shows how OSM in washcoat affects catalytic effect of ZPGM catalytic system.

As previously described, “Type 3” ZPGM catalyst system, may include a substrate, a washcoat and an overcoat. The washcoat may include alumina and at least one transition metal such as manganese. The washcoat does not include any OSM. The manganese in the washcoat may be present in about 1% to about 20%, preferably about 4% to about 10% by weight. The overcoat includes copper oxide, ceria, alumina, and at least one OSM, preferably the OSM includes a mixture of cerium, zirconium, neodymium, and praseodymium. The alumina and OSM of the overcoat may be present in the overcoat in a ratio of about 60 to about 40. The copper and cerium in the overcoat are present in about 5% to about 50%, preferably from 10% to 16% by weight of Cu and 12% to 20% by weight of Ce. Following the washcoat and overcoat steps, the heat treating may be done at a temperature between 300° C. and 700° C., preferably about 550° C. The heat treating may last from about 2 to about 6 hours, preferably about 4 hours for washcoat and overcoat.

A ZPGM catalyst system, referred to “Type 8”, may include a substrate, a washcoat and an overcoat. The washcoat may include alumina, at least one OSM, and at least one transition metal such as manganese. Preferably the OSM includes a mixture of cerium, zirconium, neodymium, and praseodymium. OSM may be present in the washcoat in a ratio of about 60 to about 40. The manganese in the washcoat may be present in about 1% to about 20%, preferably about 4% to about 10% by weight. The overcoat may include copper oxide, ceria, and alumina. The overcoat includes at least one OSM. OSM may be present in the overcoat in a ratio of about 60 to about 40. The copper and cerium in the overcoat may be present in about 5% to about 50%, preferably about 10% to 16% by weight of Cu and 12% to 20% by weight of Ce. Following the washcoat and overcoat steps, the heat treating may be done at a temperature between 300° C. and 700° C., preferably about 550° C. The heat treating may last from about 2 to about 6 hours, preferably about 4 hours for washcoat and overcoat.

FIG. 3 shows the light-off test results for “Type 3” and “Type 8” ZPGM catalyst systems 300, where the effect of removal of OSM from washcoat is present. The light-off test of “Type 3” and “Type 8” ZPGM catalyst systems was performed where propane is the feed hydrocarbon under rich condition with R-value=1.224. Both catalysts are aged at 900° C. for 4 hours. FIG. 3 shows that the presence of OSM in washcoat may show an improvement of about 20° C. in HC, CO and NO conversion.

### Example 5

Example 5 shows ZPGM catalytic systems that includes different manganese loading in the washcoat.

“Type 9” ZPGM catalyst system is a “Type 3” ZPGM catalyst system where the alumina in washcoat is doped with SiO₂ (Aluminia-5% SiO₂). “Type 9” ZPGM catalyst system may include a substrate, a washcoat and an overcoat. The washcoat may include alumina and at least one transition metal such as manganese. The manganese in the washcoat may be present in about 1% to about 20% by weight. The overcoat includes copper oxide, ceria, alumina, and at least one OSM, preferably OSM in overcoat may include a mixture of cerium, zirconium, neodymium, and praseodymium. OSM may be present in the overcoat in a ratio of about 60 to about 40. The alumina may be a lanthanum doped alumina. The copper and cerium in the overcoat may be present in about 5% to about 50%, preferably about 10% to 16% by weight of Cu and 12% to 20% by weight of Ce. Following the washcoat and overcoat steps, the heat treating may be done at a temperature between 300° C. and 700° C., preferably about 550° C. The treating may last from about 2 to about 6 hours, preferably about 4 hours for washcoat and overcoat.

FIG. 4 shows the light-off test results of Mn loading in “Type 9” ZPGM catalyst system 400 where the manganese in the washcoat may be present about 3%, 5% and 10% by weight. The light-off test of “Type 9” ZPGM catalyst systems 400 was performed where propane is the feed hydrocarbon under rich condition with R-value=1.224. catalysts are aged at 900 C for 4 hours. The “Type 9” ZPGM catalyst systems 400 with about 5%, and 10% by weight of Mn have similar T50 for CO at about 286° C. The “Type 9” ZPGM catalyst systems 400 with about 5%, and 10% by weight of Mn have similar T50 for NO at about 380° C. The “Type 9” ZPGM catalyst systems 400 with about 5%, and 10% by weight of Mn have similar T50 for HC at about 395° C. The “Type 9” ZPGM catalyst systems 400 with about 3% by weight of Mn shows slightly better performance as is shown with HC, CO, and NO T50 at 379° C., 277° C., and 369° C., respectively.

### Example 6

Example 6 shows ZPGM catalytic systems that include different types of alumina in the washcoat.

As mentioned here, “Type 3” ZPGM catalyst system, includes a substrate a washcoat and an overcoat. The substrate may include a cordierite. The washcoat may include alumina and at least one transition metal such as manganese without any OSM. The manganese in the washcoat may be present in about 1% to about 20%, preferably about 4% to about 10% by weight. A transition metal such as manganese and a carrier material oxide may be milled together. The ZPGM catalyst may be synthesized by any chemical technique such as solid-state synthesis, precipitation, or any other technique known in the art. The milled ZPGM catalyst and carrier material oxide may be deposited on a substrate in the form of a washcoat and then heat treated. The heat treating may be done at a temperature between 300° C. and 700° C., preferably about 550° C. The heat treating may last from about 2 to about 6 hours, preferably about 4 hours.

The carrier material oxide in this example includes one or more selected from the group including aluminum oxide or doped aluminum oxide. The doped aluminum oxide in washcoat may include one or more selected from the group including lanthanum, yttrium, lanthanides and mixtures thereof. In these examples, carrier material oxide varies from pure alumina, doped alumina (4% La), doped alumina (10% La) and SiO₂ doped alumina (5% SiO₂).

FIG. 5 shows the light-off test results for “Type 3” ZPGM catalyst system 500 where the type of alumina in washcoat material is different. The light-off test of “Type 3” ZPGM catalyst systems 400 was performed where propane is the feed hydrocarbon under rich condition with R-value=1.224. catalysts are aged at 900° C. for 4 hours. “Catalyst A” is the “Type 3” ZPGM catalyst system including alumina, “Catalyst B” is the catalyst including alumina with 5% doped silicon dioxide (5% SiO₂), “Catalyst C” is the “Type 3” ZPGM catalyst system including alumina with 4% doped La (4% La), and “Catalyst D” is the “Type 3” ZPGM catalyst system including alumina with 10% doped La (10% La). FIG. 5 shows Catalyst D with 10% doped La shows significantly improvement of HC over wide range of temperature and significant improvement of NO conversion at high temperature (above 400° C.) compare to catalyst A, B and C. These results show that increasing the La content will improve NO and HC conversion under rich condition.

The above description is for the purpose of teaching the person of ordinary skill in the art how to practice the disclosure. It is not intended to detail all of those obvious modifications and variations, which will become apparent to the skilled worker upon reading the description. It is intended, however, that all such obvious modifications and variations be included with the scope of the disclosure which is defined by the following claims. The claims are meant to cover the claimed components and steps in any sequence that is effective to meet the objectives there intended, unless the context specifically indicates the contrary.

While various aspects and embodiments have been disclosed here, other aspects and embodiments may be contemplated. The various aspects and embodiments disclosed here are for purposes of illustration with the true scope and spirit being indicated by the following claims.

What is claimed is:

1. An apparatus for reducing emissions from an engine having associated therewith an exhaust system, the apparatus providing a reaction effective for selective catalytic reduction, comprising:
at least one source of exhaust comprising hydrocarbons and carbon monoxide; and
a catalyst system, comprising:
a substrate;
a catalyst;
a washcoat suitable for deposition on the substrate; and
an overcoat suitable for deposition on the substrate or the washcoat;
wherein the catalyst comprises about 10% to about 16% by weight of copper, about 12% to about 20% by weight of cerium, and about 5% to about 10% by weight of manganese; and
wherein the catalyst is suitable for deposition on a coat selected from the group consisting of at least one of the washcoat and the overcoat.

2. The apparatus of claim 1, wherein the washcoat further comprises at least one oxide solid selected from the group consisting of at least one of a carrier metal oxide, and a catalyst.

3. The apparatus of claim 1, wherein the overcoat further comprises at least one overcoat oxide solid selected from the group consisting of a carrier metal oxide, and a catalyst, and at least one oxygen storage material, wherein the carrier metal oxide comprises at least one selected from the group consisting of alumina, lanthanum-doped alumina, and SiO₂-doped alumina.

4. The apparatus of claim 1, wherein the catalyst is prepared by a method selected from the group consisting of co-milling, co-precipitation, impregnation, and stabilization.

5. The apparatus of claim 1, wherein the catalyst comprises about 10% by weight of copper and 12% by weight of cerium.

6. The apparatus of claim 1, wherein the catalyst system oxidizes a plurality of the hydrocarbons and the carbon monoxide.

7. The apparatus of claim 1, wherein the T50 conversion temperature for the hydrocarbons is less than 450 degrees Celsius.

8. The apparatus of claim 1, wherein the T50 conversion temperature for nitrogen oxide is about 350 degrees Celsius.

9. The apparatus of claim 1, wherein the T50 conversion temperature for the carbon monoxide is less than about 200 degrees Celsius.

10. The apparatus of claim 1, wherein at least one of the washcoat and the overcoat comprises a carrier metal oxide, and wherein the carrier metal oxide is selected from the group consisting of at least one of Al₂O₃, CeO₂, ZrO₂, and TiO₂.

11. The apparatus of claim 10, wherein the catalyst is deposited on the carrier metal oxide.

12. The apparatus of claim 1, wherein at least one of the washcoat and the overcoat further comprises an oxygen storage material, and wherein the oxygen storage material is selected from the group consisting of at least one of cerium, zirconium, neodymium, and praseodymium.

13. The apparatus of claim 1, wherein the washcoat further comprises at least one oxygen storage material.

14. The apparatus of claim 1, wherein the catalyst converts at least the hydrocarbons, nitrogen oxide, and the carbon monoxide

15. The apparatus of claim 1, wherein the catalyst system oxidizes at least one of the hydrocarbons and the carbon monoxide

16. A zero platinum group metal (ZPGM) catalyst system, comprising:
a substrate;
a washcoat suitable for deposition on the substrate, comprising at least one oxide solid selected from the group consisting of at least one of a carrier metal oxide, and a ZPGM catalyst; and
an overcoat suitable for deposition on the substrate, comprising at least one overcoat oxide solid selected from the group consisting of at least one of a carrier metal oxide, and a ZPGM catalyst;
wherein at least one of the ZPGM catalysts comprises at least one perovskite structured compound having a formula ABO₃, wherein A is selected from the group consisting of at least one of, magnesium, calcium, barium, strontium, and mixtures thereof, and wherein B comprises at least one transition metal.

17. The catalyst system of claim 16, wherein the transition metal is selected from the group consisting of at least one of iron, manganese, copper, nickel, and cobalt.

18. The catalyst system of claim 16, wherein the at least one perovskite structured compound has the formula AMn₁-xCuₓO₃, wherein A is selected from the group consisting of at least one of lanthanum, cerium, barium, strontium, a lanthanide, and an actinide, and wherein x is 0 to 1.

19. The catalyst system of claim 16, wherein the at least one perovskite structured compound having the formula ABO₃ is ACe₁-xCuₓO₃, wherein A is manganese, and wherein x is 0 to 1.

20. The catalyst system of claim 16, wherein the concentration of the at least one perovskite structured compound is about 10 g/L to about 180 g/L.

21. The catalyst system of claim 16, wherein the concentration of the at least one perovskite structured compound is about 5% to about 50% by weight.

22. The catalyst of claim 16, wherein the at least one perovskite structured compound having the formula ABO₃ is AB₁-xMₓO₃, wherein x is 0 to 1.

23. A zero platinum group metal (ZPGM) catalyst system, comprising:
a substrate;
a washcoat suitable for deposition on the substrate, comprising at least one oxide solid selected from the group consisting at least one of a carrier metal oxide, and a ZPGM catalyst; and
an overcoat suitable for deposition on the substrate, comprising at least one overcoat oxide solid selected from the group consisting at least one of a carrier metal oxide, and a ZPGM catalyst;
wherein at least one of the ZPGM catalysts comprises at least one spinel structured compound having the formula AB₂O₄, wherein each of A and B is selected from the group consisting at least one of aluminum, magnesium, manganese, gallium, nickel, copper, cobalt, molybdenum, vanadium, iron, chromium, titanium, and tin.

24. The catalyst system of claim 23, wherein the at least one spinel structured compound having the formula AB₂O₄ is CuMn₂O₄.

25. The catalyst system of claim 23, wherein at least one of the ZPGM catalysts further comprises at least one carrier material oxide.

26. The catalyst system of claim 23, wherein the spinel is present in about 5% to about 50% by weight.

27. The catalyst system of claim 23, wherein a conversion temperature for hydrocarbon is about 165° C.

28. The catalyst system of claim 23, wherein a conversion temperature for nitrogen oxide is about 80° C.

29. A method of making a zero platinum group metal (ZPGM) catalyst system, comprising:
depositing at least one washcoat and at least one transition metal salt on to a substrate;
heat treating the washcoat for about 2 to about 6 hours at about 300° C. to about 700° C.;
depositing at least one overcoat comprising an overcoat oxide solid selected from the group consisting at least one of a carrier metal oxide, and a ZPGM catalyst;
wherein the ZPGM catalyst comprises at least one spinel structured compound having the formula AB₂O₄, wherein each of A and B is selected from the group consisting of at least one of aluminum, magnesium, manganese, gallium, nickel, copper, cobalt, molybdenum, vanadium, iron, chromium, titanium and tin.

30. The method of claim 29, wherein the at least one spinel structured compound is CuMn₂O₄.

31. The method of claim 29, wherein the catalyst further comprises at least one carrier material oxide.

32. The method of claim 29, wherein the spinel is present in about 5% to about 50% by weight.

33. The method of claim 29, wherein a conversion temperature for hydrocarbon is about 165° C.

34. The method of claim 29, wherein a conversion temperature for nitrogen oxide is about 80° C.

35. The method of claim 29, wherein the transition metal salt is precipitated.

36. The method of claim 29, wherein the heat treating of the washcoat is at about 550° C. for about 4 hours.

37. An apparatus for reducing emissions from an engine having associated therewith an exhaust system, the apparatus providing a reaction effective for selective catalytic reduction, comprising:
at least one source of exhaust comprising hydrocarbons and carbon monoxide; and
a catalyst system, comprising:
a substrate;
a catalyst;
a washcoat suitable for deposition on the substrate; and
an overcoat suitable for deposition on the substrate or the washcoat;
wherein the catalyst is selected from the group consisting at least one of copper, cerium, manganese, and silver; and
wherein the catalyst is suitable for deposition on a coat selected from the group consisting of at least one of the washcoat and the overcoat.

38. The apparatus of claim 37, wherein the catalyst is prepared by a method selected from the group consisting of co-milling, co-precipitation, impregnation, and stabilization.

39. The apparatus of claim 37, wherein the catalyst comprises about 4% to about 10% by weight of silver.

40. The apparatus of claim 37, wherein the catalyst comprises about 10% to 16% by weight of copper.

41. The apparatus of claim 37, wherein the catalyst comprises about 12% to 20% by weight of cerium.

42. A zero platinum group metal (ZPGM) catalyst system, comprising:
a substrate;
a washcoat suitable for deposition on the substrate, comprising at least an OSM and at least one oxide solid selected from the group consisting of at least one of a carrier metal oxide, and a ZPGM catalyst; and
an overcoat suitable for deposition on the substrate, comprising at least an OSM and at least one overcoat oxide solid selected from the group consisting of at least one of a carrier metal oxide, and a ZPGM catalyst;
wherein at least one of the ZPGM catalysts comprises either a perovskite structured compound or a spinel structured compound.
